(19) United States
(12) Patent Application Publication
(10) Pub. No.: US 2022/0091693 A1
(43) Pub. Date: Mar. 24, 2022

(54) INPUT DEVICE

(71) Applicant: ALPS ALPINE CO., LTD., Tokyo (JP)

(72) Inventors: Toshiki NAKAMURA, Miyagi (JP); Yasuji HAGIWARA, Miyagi (JP)

(21) Appl. No.: 17/457,296

(22) Filed: Dec. 2, 2021

Related U.S. Application Data
(63) Continuation of application No. PCT/JP2020/011980, filed on Mar. 18, 2020.

(30) Foreign Application Priority Data
Jun. 17, 2019 (JP) 2019-112066

(51) Int. Cl. G06F 3/041; G06F 3/0362

(52) U.S. Cl. CPC G06F 3/0418; G06F 3/0362

(57) ABSTRACT

An input device having excellent usability is provided. The input device includes a touch input part configured to receive an input of a touch operation by an operator, a rotation input part disposed around the touch input part in plan view and configured to receive an input of a rotation operation by the operator, and a controller configured to disable the input of the touch operation on the touch input part in response to the input of the rotation operation of the rotation input part being performed.

### CROSS-REFERENCE TO RELATED APPLICATIONS

This application is a continuation of International Application No. PCT/JP2020/011980, filed on Mar. 18, 2020 and designating the U.S., which claims priority to Japanese Patent Application No. 2019-112066, filed on Jun. 17, 2019. The contents of these applications are incorporated herein by reference in their entirety.

### BACKGROUND OF THE INVENTION

### 1. Field of the Invention

The disclosure herein relates to an input device.

### 2. Description of the Related Art

Conventionally, an input device is known that includes a first detecting unit configured to detect the rotation of a dial-type rotation operation member, and includes a second detecting unit configured to detect a touch operation on a touch operation part attached to the inner surface of the rotation operation member (see Patent Document 1, for example).

In the conventional input device, if a user unintentionally touches the touch operation part attached to the inner surface of the rotation operation member with the finger while rotating the rotation operation member, a touch operation may be detected even if the user does not intend to perform the touch operation. In such a case, the user cannot perform an operation as desired. Thus, the usability of the conventional input device is not favorable.

### RELATED-ART DOCUMENTS

### Patent Documents

Patent Document 1: Japanese Laid-open Patent Publication No. 2014-216082

### SUMMARY OF THE INVENTION

It is desirable to provide an input device having excellent usability.

According to an embodiment of the present invention, an input device includes a touch input part configured to receive an input of a touch operation by an operator, a rotation input part disposed around the touch input part in plan view and configured to receive an input of a rotation operation by the operator, and a controller configured to disable the input of the touch operation on the touch input part in response to the input of the rotation operation of the rotation input part being performed.

### BRIEF DESCRIPTION OF THE DRAWINGS

Other objects and further features of the present invention will be apparent from the following detailed description when read in conjunction with the accompanying drawings, in which:

FIG. 1 is a diagram illustrating an input device 100 according to an embodiment;

FIG. 2 is an exploded perspective view of a mechanism for detecting the amount of rotation of a dial 130;

FIG. 3 is a plan view illustrating a configuration of fixed electrode groups 134 and a drive electrode 136;

FIG. 4 is a diagram illustrating overlap between the fixed electrode groups 134 and a movable electrode 132 in plan view;

FIG. 5 is a diagram illustrating an example of the overall configuration of the input device 100;

FIG. 6 is a graph illustrating a detection principle of a rotation operation in the input device 100;

FIG. 7 is a flowchart illustrating a process performed by a main control unit 161;

FIG. 8A and FIG. 8B are diagrams illustrating an example of the use of the input device 100; and

FIG. 9A and FIG. 9B are diagrams illustrating another example of the use of the input device 100.

### DESCRIPTION OF THE EMBODIMENTS

According to an embodiment of the present invention, an input device having excellent usability can be provided.

In the following, an input device according to an embodiment of the present invention will be described.

### Embodiment

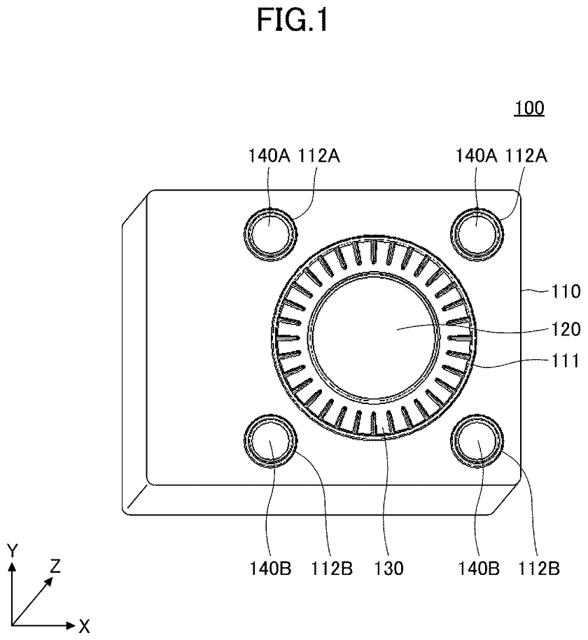

FIG. 1 is a diagram illustrating an input device 100 according to an embodiment. In the following, an XYZ Cartesian coordinate system is used for description, and a plan view refers to a view in the XY plane. Further, for convenience of description, the positive Z-side is referred to as an upper side and the negative Z-side is referred to as a lower side, but this positional relationship does not represent a universal relationship.

The input device 100 includes a housing 110, a touchpad 120, a dial 130, indicators 140A, and buttons 140B. The input device 100 is, for example, a device that is connected to an electronic control unit (ECU) of a vehicle or a computer such as a personal computer or a server, and outputs an operation signal corresponding to a touch operation of the touchpad 120 or corresponding to a rotation operation of the dial 130 to the ECU or the computer. Specifically, the operation signal indicates the details of the touch operation or the rotation operation.

The housing 110 is a rectangular-shaped case, and the top surface of the housing 110 has openings 111, 112A, and 112B. The opening 111 is provided approximately at the center of the top surface of the housing 110, and the openings 112A and 112B are provided around the opening 111 in plan view. The number of the openings 112A is two, and one of the openings 112A is provided on the +X side and the +Y side, and the other opening 112A is provided on the −X side and the +Y side. Further, the number of the openings 112B is two, and one of the openings 112B is provided on the +X side and the −Y side, and the other opening 112B is provided on the −X side and the −Y side.

The touchpad 120 is an example of a touch input part configured to receive an input of a touch operation by an operator. The touchpad 120 is provided so as to project from the center portion of the opening 111. The touchpad 120 has a circular shape in plan view, and is surrounded by the dial 130. As used herein, the touch operation refers to an input operation performed by a user touching the surface of the touchpad 120 with a part of the user's body such as the finger, or moving the part of the user's body such as the finger while touching the surface of the touchpad 120. The touchpad 120 is, for example, a capacitive touch panel. Alternatively, the touchpad 120t may be a resistive touch panel.

The dial 130 is an example of a rotation input part configured to receive an input of a rotation operation by the operator, and is an annular input part provided around the touchpad 120. The input of the rotation operation is an input operation in which the user rotates the dial 130 by touching the dial 130 with a part of the user's body such as the finger.

The dial 130 is configured to provide a clicking sensation for each predetermined rotation angle when a rotation operation is performed by the operator (that is, when the dial 130 is rotated by the operator). The predetermined rotation angle is, for example, 45 degrees. Such a clicking sensation can be achieved by providing a protrusion on the outer periphery of a rotating shaft of the dial 130 for each of the predetermined rotation angles, and causing a reaction force to be transmitted to the dial 130 when the dial 130 moves over the protrusion in accordance with a rotation operation of the dial 130. In the following description, the dial 130 is configured to be able to provide a clicking sensation; however, the dial 130 is not necessarily configured to provide a clicking sensation.

The indicators 140A are illumination parts configured to illuminate in response to the operation of the touchpad 120, the dial 130, or the buttons 140B. The number of the indicators 140A is two, and the two indicators 140A project from the two respective openings 112A. The indicators 140A may be light emitting diodes (LEDs) or the like, and indicate an operation mode or the like determined by an input operation performed with respect to the input device 100.

The number of the buttons 140B is two, and the two buttons 140B project from the two respective openings 112B. The buttons 140B are configured to select predetermined functions or the like of the input device 100.

In the following description, the input device 100 includes the indicators 140A and the buttons 140B; however, the input device 100 may be configured to include one or more buttons 140B without including the indicators 140A.

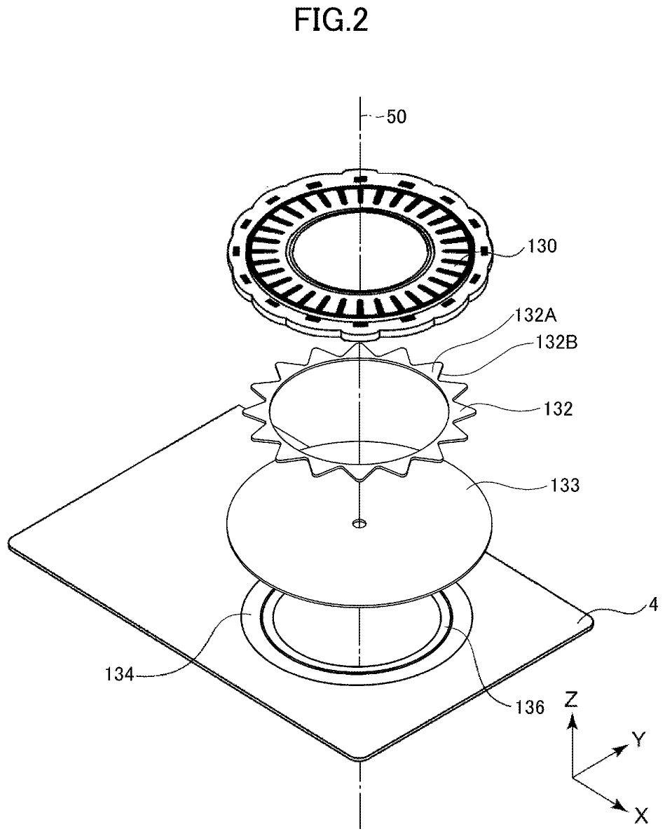

FIG. 2 is an exploded perspective view of a mechanism for detecting the amount of rotation of the dial 130. In FIG. 2, only the mechanism for detecting the amount of rotation of the dial 130 included in the housing 110 (see FIG. 1) is depicted.

The mechanism for detecting the amount of rotation of the dial 130 includes a movable electrode 132, a spacer sheet 133, fixed electrode groups 134, and a drive electrode 136.

The movable electrode 132 is a conductor plate having an approximately ring shape about a rotation axis 50 in plan view.

The movable electrode 132 includes a base portion 132A having an annular shape about the rotation axis 50, and includes outer edge portions 132B located outward relative to the base portion 132A and formed in a sinusoidal shape.

The movable electrode 132 is attached to the bottom surface of the dial 130 (see FIG. 1). Accordingly, the movable electrode 132 rotates by causing the dial 130 to rotate about the rotation axis 50.

The spacer sheet 133 made of an insulator and having a circular shape is disposed between the dial 130 and the fixed electrode groups 134 and the drive electrode 136. The spacer sheet 133 is not necessarily disposed if the movable electrode 132 does not contact a substrate 4.

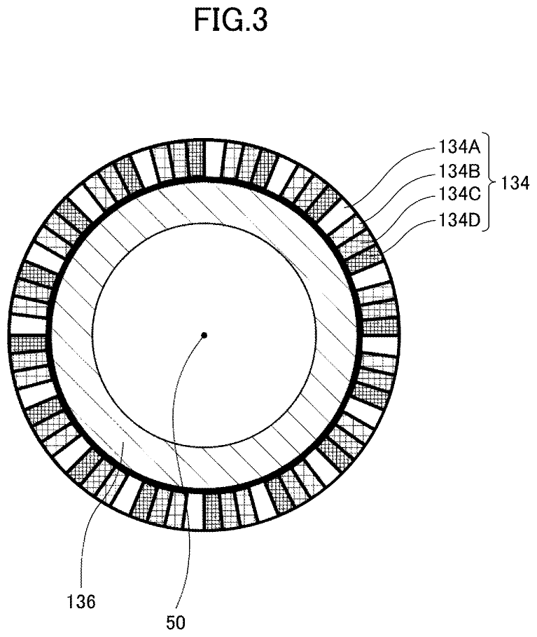

FIG. 3 is a plan view illustrating a configuration of the fixed electrode groups 134 and the drive electrode 136.

The sixteen fixed electrode groups 134 are annularly arranged at equal angular intervals about the rotation axis 50.

The drive electrode 136 is located closer to the rotation axis 50 than the fixed electrode groups 134, and is formed in an annular shape about the rotation axis 50. One fixed electrode group 134 occupies an angle range of approximately 1/16 of one rotation. The fixed electrode groups 134 are provided radially outward from the drive electrode 136.

With the above-described configuration, the movable electrode 132 faces the sixteen fixed electrode groups 134 so as to form capacitors. Specifically, the outer edge portions 132B of the movable electrode 132 face the sixteen fixed electrode groups 134, and the capacitances of capacitors formed between the outer edge portions 132B and the fixed electrode groups 134 change with the rotation of the dial 130.

Further, the base portion 132A of the movable electrode 132 faces the drive electrode 136, and the capacitance of a capacitor formed between the base portion 132A and the drive electrode 136 is constant regardless of the rotation of the dial 130.

Each of the fixed electrode groups 134 includes four fixed electrodes 134A, 134B, 134C, and 134D arranged at equal angular intervals and in an arc shape in the circumferential direction about the rotation axis 50 of the dial 130. Each of the fixed electrodes 134A, 134B, 134C, and 134D has an approximately fan shape, and occupies an angular range of approximately 1/64 of one rotation about the rotation axis 50.

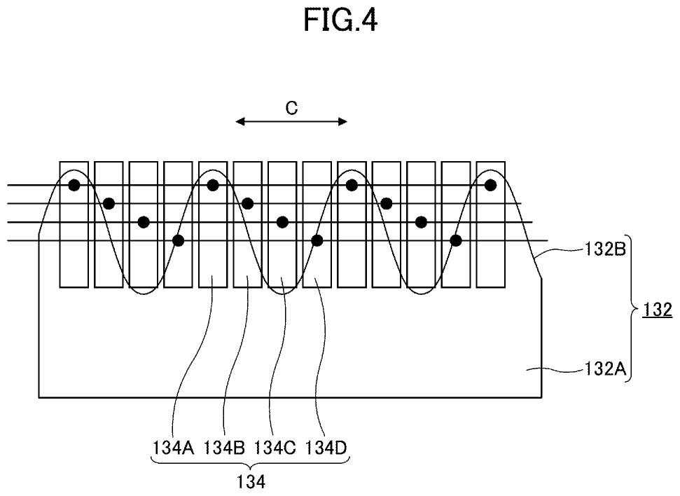

FIG. 4 is a diagram illustrating overlap between the fixed electrode groups 134 and the movable electrode 132 in plan view. In FIG. 4, the edges of electrodes curved in an arc shape are depicted in a linear shape for ease of understanding. In FIG. 4, C denotes the circumferential direction.

As illustrated in FIG. 4, in plan view, the outer edge portions 132B of the movable electrode 132 overlap the fixed electrode groups 134, each of which includes the fixed electrodes 134A through 134D. The period of the sinusoidal shape of the outer edge portions 132B of the movable electrode 132 coincides with the period of arrangement of the fixed electrode groups 134. One period of the sinusoidal shape of the outer edge portions 132B corresponds to an angle range of 1/16 of one rotation about the rotation axis 50.

For example, if the phase of the capacitance between the movable electrode 132 and a fixed electrode 134A is the most advanced, the phases of the capacitances between the movable electrode 132 and three fixed electrodes 134B, 134C, and 134D are delayed by π/2 [rad] with respect to each other.

The capacitance of a capacitor formed between each of fixed electrodes 134A through 134D and an outer edge portion 132B of the movable electrode 132 is approximately proportional to an overlapping area between each of the fixed electrodes 134A through 134D and the outer edge portion 132B in plan view. As the movable electrode 132 rotates in accordance with the rotation operation of the dial 130, the outer edge portion 132B changes in position relative to the fixed electrodes 134A through 134D, and thus, the overlapping area between the fixed electrodes 134A through 134D and the outer edge portion 132B of the movable electrode 132 changes.

Accordingly, the capacitances of capacitors between the outer edge portions 132B of the movable electrode 132 and the fixed electrode groups 134 sinusoidally change. In the present embodiment, because the sixteen fixed electrode groups 134 are provided, sixteen cycles of periodic changes occur in the capacitance of a capacitor during one rotation of the dial 130 from a reference position. One period of the sinusoidal shape of the outer edge portions 132B corresponds to an angle range of 1/16 of one rotation about the rotation axis 50.

As illustrated in FIG. 4, when the fixed electrode 134A is positioned at a peak of the sinusoidal shape of an outer edge portion 132B of the movable electrode 132, the outer edge portion 132B of the movable electrode 132 overlaps almost the entire fixed electrode 134A. At this time, the capacitance between the outer edge portion 132B of the movable electrode 132 and the fixed electrode 134A reaches the maximum value.

As illustrated in FIG. 4, when the fixed electrode 134C is positioned at a peak of the sinusoidal shape of the outer edge portion 132B of the movable electrode 132, the outer edge portion 132B of the movable electrode 132 does not overlap the fixed electrode 134C. At this time, the capacitance between the outer edge portion 132B of the movable electrode 132 and the fixed electrode 134C reaches the minimum value.

As described, for the outer edge portions 132B of the movable electrode 132, the capacitance of a capacitor formed between each of the fixed electrodes 134A through 134D and the outer edge portion 132B of the movable electrode 132 is approximately proportional to an overlapping area between each of the fixed electrodes 134A through 134D and the outer edge portion 132B in plan view.

As the movable electrode 132 rotates in accordance with the rotation operation of the dial 130, the outer edge portion 132B changes in position relative to the fixed electrodes 134A through 134D, and thus, the overlapping area between the fixed electrodes 134A through 134D and the outer edge portion 132B of the movable electrode 132 changes.

Accordingly, the capacitances of capacitors between the outer edge portions 132B of the movable electrode 132 and the fixed electrode groups 134 sinusoidally change. In the present embodiment, because the sixteen fixed electrode groups 134 are provided, sixteen cycles of periodic changes occur in the capacitance of a capacitor during one rotation of the dial 130 from a reference position.

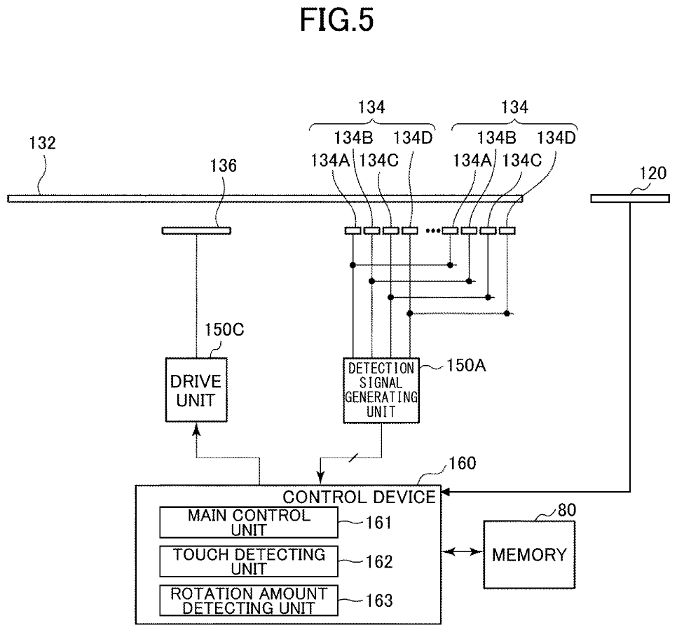

FIG. 5 is a diagram illustrating an example of the overall configuration of the input device 100. The input device 100 includes a detection signal generating unit 150A, a drive unit 150C, a control device 160, and a memory 80, in addition to the above-described configuration.

The detection signal generating unit 150A is configured to generate a group of detection signals in accordance with the capacitances of the capacitors formed between the sixteen fixed electrodes 134 and the movable electrode 132. The detection signal generating unit 150A includes, for example, a capacitance-voltage conversion circuit (a CV conversion circuit) and an AD conversion circuit that converts the output voltage to a digital signal.

The drive unit 150C is configured to supply a drive voltage to the drive electrode 136. The drive voltage supplied by the drive unit 150C is controlled by the control device 160.

Therefore, when the dial 130 rotates while the drive voltage is supplied to the drive electrode 136, the capacitances of the capacitors formed between the sixteen fixed electrode groups 134 and the movable electrode 132 change periodically.

The sixteen fixed electrode groups 134 are electrically connected by a wiring pattern formed on the substrate 4 on which the fixed electrode groups 134 are provided. Specifically, fixed electrodes 134A of the sixteen fixed electrode groups 134, that is, sixteen fixed electrodes 134A are connected to the detection signal generating unit 150A by common wiring. In addition, sixteen fixed electrodes 134B, sixteen fixed electrodes 134C, and sixteen fixed electrodes 134D are connected to the detection signal generating unit 150A by common wiring.

When a predetermined driving voltage is applied to the drive electrode 136 by the drive unit 150C, charges corresponding to capacitances, which correspond to the respective overlapping areas between the fixed electrodes 134A and the movable electrode 132, are accumulated in capacitors formed between the sixteen fixed electrodes 134A and the movable electrode 132. The same applies to the sixteen fixed electrodes 134B, 134C, and 134D.

The detection signal generating unit 150A generates, as detection signals (SA, SB, SC, and SD), signals corresponding to the sums of positive charges and negative charges accumulated in sixteen capacitors.

The control device 160 includes a main control unit 161, a touch detecting unit 162, and a rotation amount detecting unit 163. The control device 160 is an example of a controller that controls the overall operation of the input device 100, performs signal processing, and the like. The control device 160 is implemented by, for example, a computer that performs processes based on a program stored in the memory 80. Some of the processes performed by the control device 160 may be performed by dedicated hardware (such as an application-specific integrated circuit (ASIC)).

The main control unit 161 performs a process other than processes performed by the touch detecting unit 162 and the rotation amount detecting unit 163. First, the processes performed by the touch detecting unit 162 and the rotation amount detecting unit 163 will be described before describing the process performed by the main control unit 161.

The touch detecting unit 162 is configured to detect a touch operation performed on the touchpad 120 based on position data, which is received from the touchpad 120.

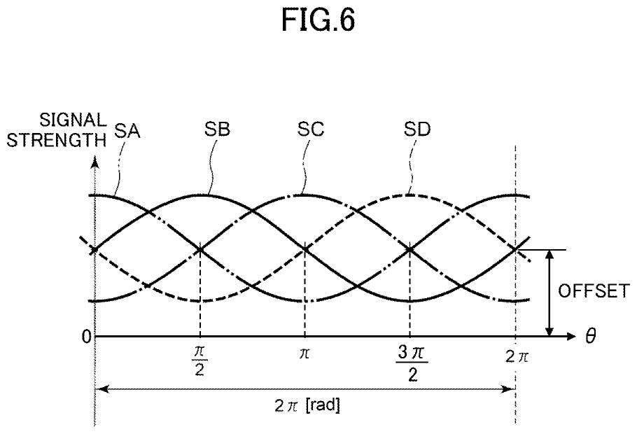

The rotation amount detecting unit 163 is configured to detect the amount of rotation of the dial 130. A specific detection method will be described with reference to FIG. 6.

FIG. 6 is a graph illustrating a detection principle of a rotation operation in the input device 100. In the graph illustrated in FIG. 6, the signal strengths of detection signals SA, SB, SC, and SD, generated by the detection signal generating unit 150A based on signals output from the fixed electrodes 134A, 134B, 134C, and 134D when the movable electrode 132 is rotated by operating the dial 130, is plotted with respect to an angle θ. The detection signals SA, SB, SC, and SD correspond to the signals output from the fixed electrodes 134A, 134B, 134C, and 134D, respectively. The periods and amplitudes of the detection signals SA, SB, SC, and SD are the same, and the detection signals SA, SB, SC, and SD have waveforms whose phases are shifted by π/2 [rad] with respect to each other.

As an example, the waveform of the detection signal SA when a positive drive voltage is applied to the drive electrode 136 will be described. The same can apply to the detection signals SB, SC, and SD.

When the angle θ is 0, the value of the detection signal SA indicates a positive peak value. At this time, an outer edge portion 132B of the movable electrode 132 entirely overlaps a fixed electrode 134A, and positive charges are accumulated in a capacitor formed between the outer edge portion 132B of the movable electrode 132, corresponding to the drive electrode 136, and the fixed electrode 134A. Accordingly, the detection signal generating unit 150A generates a signal corresponding to the positive charges accumulated in the capacitor formed between the outer edge portion 132B of the movable electrode 132 and the fixed electrode 134A.

Further, when the angle θ is π/2, the value of the detection signal SA indicates the median value of the amplitude. At this time, the outer edge portion 132B overlaps the half of the fixed electrode 134A. Accordingly, the detection signal generating unit 150A generates a signal corresponding to positive charges accumulated in the capacitor formed between the outer edge portion 132B of the movable electrode 132 and the fixed electrode 134A.

Further, when the angle θ is π, the value of the detection signal SA indicates the bottom value. At this time, the outer edge portion 132B of the movable electrode 132 does not overlap the fixed electrode 134A, and no charges are accumulated in the capacitor formed between the outer edge portion 132B of the movable electrode 132, corresponding to the drive electrode 136, and the fixed electrode 134A. Accordingly, the detection signal generating unit 150A generates a signal corresponding to a state in which no charges are accumulated. The median value of the amplitude of the signal strength of each of the detection signals SA, SB, SC, and SD is offset with respect to the point at which the signal strength is zero.

The rotation amount detecting unit 163 performs a process for obtaining information relating to the rotation of the dial 130 based on a group of detection signals (a first detection signal SA, a second detection signal SB, a third detection signal SC, and a fourth detection signal SD) generated by the detection signal generating unit 150A. Specifically, the rotation amount detecting unit 163, which serves as an angle calculating unit, controls the drive unit 150C to apply a drive voltage to the drive electrode 136, and acquires information (for example, the rotation angle) relating to the rotation of the dial 130 based on the first detection signal SA, the second detection signal SB, the third detection signal SC, and the fourth detection signal SD generated in response to the application of the drive voltage.

Next, the detection of a rotation operation in the input device 100 having the above-described configuration will be described.

### Detection of Rotation Operation

In order to detect a rotation operation, the drive unit 150C applies a drive voltage to the drive electrode 136. In response to the drive voltage being applied, the detection signal generating unit 150A generates four detection signals (SA, SB, SC, and SD). The four detection signals (SA, SB, SC, and SD) correspond to charges accumulated in capacitors formed between four fixed electrodes (134A through 134D) of the fixed electrode groups 134 and the movable electrode 132. The signal strengths of the four detection signals (SA, SB, SC, and SD) are generally expressed by equations below.

SA=K·cos(16θ) (1)

SB=K·sin(16θ) (2)

SC=−K·cos(16θ) (3)

SD=−K·sin(16θ) (4)

In the equations above, “θ” denotes the rotation angle of the dial 130, and “K” denotes a proportional constant. In the equations (1) to (4) above, “θ” is multiplied by “16”, which indicates that there are 16 cycles of changes in each of the detection signals (SA through SD) during one rotation of the dial 130. That is, the rotation amount detecting unit 163 can perform detection with a resolution obtained by dividing one rotation (360 degrees) of the dial 130 by 16. In other words, the resolution of the rotation amount detecting unit 163 for the rotation angle of the dial 130 corresponds to a detectable amount of rotation, that is, 22.5 degrees. This is one-half of a click interval (45 degrees) of the dial 130.

As illustrated in FIG. 6, the phases of the four detection signals (SA, SB, SC, and SD) are shifted by 90° (π/2 [rad]) or 180° (π [rad]) with respect to each other, and have different values.

The difference “SA−SC” between the first detection signal SA and the third detection signal SC whose phases are shifted by 180 degrees, and the difference “SB−SD” between the second detection signal SB and the fourth detection signal SD whose phases are shifted by 180 degrees are expressed by equations below, respectively.

SA−SC=2K·cos(16θ) (5)

SB−SD=2K·sin(16θ) (6)

The amplitude of “SA−SC” and the amplitude of “SB−SD” are approximately twice the amplitude of the original detection signals (SA, SB, SC and SD).

Further, “θ” is expressed by an equation below based on the equations (5) and (6).

θ=( 1/16)·A tan 2{(SB−SD), (SA−SC)} (7)

The rotation amount detecting unit 163 determines the direction of rotation of the dial 130 based on changes in polarities and values of “SA−SC” represented by the equation (5) and “SB−SD” represented by the equation (6).

Further, the rotation amount detecting unit 163 calculates the rotation angle (amount of rotation) of the dial 130 from a starting position, based on the number of cycles of periodic changes, which occur in the difference “SA−SC” (or “SB−SD”) between detection signals by a rotation operation from the starting position, and also based on “θ” calculated by the equation (7).

Note that when signals simultaneously output from fixed electrodes are used to generate detection signals SA, SB, SC, and SD by the detection signal generating unit 150A and the difference “SA−SC” or the difference “SB−SD” is calculated based on these detection signals, this means that the difference is calculated by using simultaneously measured data. Therefore, the noise to an IC power supply and sensor wiring can be eliminated.

Next, the process performed by the main control unit 161 will be described. An outline of the process performed by the main control unit 161 is as follows.

The main control unit 161 disables an input of a touch operation on the touchpad 120 when a rotation operation of the dial 130 is input. The main control unit 161 enables an input of a touch operation on the touchpad 120 when a rotation operation of the dial 130 is not input.

Specifically, when the amount of rotation detected by the rotation amount detecting unit 163 is greater than or equal to N times (N is an integer greater than or equal to 2) the angle defined by the resolution of the rotation amount detecting unit 163, the main control unit 161 disables an input of a touch operation on the touchpad 120 and receives an input of a rotation operation detected by the rotation amount detecting unit 163.

The expression “disabling a touch operation” means that even when a touch operation is detected by the touch detecting unit 162, an operation signal corresponding to the touch operation is not output to the ECU or the computer.

Further, the expression “receiving an input of a rotation operation” detected by the rotation amount detecting unit 163 means that an operation signal corresponding to a rotation operation detected by the rotation amount detecting unit 163 is output to the ECU or the computer.

When the amount of rotation detected by the rotation amount detecting unit 163 is less than M times (M is an integer that is greater than or equal to 1 and less than or equal to N) the angle defined by the resolution of the rotation amount detecting unit 163, the main control unit 161 disables an input of a rotation operation detected by the rotation amount detecting unit 163 and does not disable (that is, enables) an input of a touch operation on the touchpad 120. The amount of rotation that is less than M times the angle defined by the resolution of the rotation amount detecting unit 163 means that the amount of rotation is not greater than or equal to M times the angle defined by the resolution of the rotation amount detecting unit 163.

The expression “not disabling (enabling) an input of a touch operation” means that when a touch operation is detected by the touch detecting unit 162, an operation signal corresponding to the touch operation is output to the ECU or the computer.

Further, the expression “disabling an input of a rotation operation” detected by the rotation amount detecting unit 163 means that an operation signal corresponding to a rotation operation detected by the rotation amount detecting unit 163 is not output to the ECU or the computer.

For example, in a case where the resolution is as high as 1/100 of 360 degrees, an input of a rotation operation of the dial 130 may be detected by the rotation amount detecting unit 163 if the user unintentionally touches and rotates the dial 130 while operating the touchpad 120. In such a case, when a rotation operation of the dial 130 that is greater than or equal to N times (an integer multiple greater than or equal to 2, because N is an integer greater than or equal to 2) the angle defined by the resolution of the rotation amount detecting unit 163 is input, the input of the rotation operation of the dial 130 may be received. In this manner, an unintentional input can be avoided.

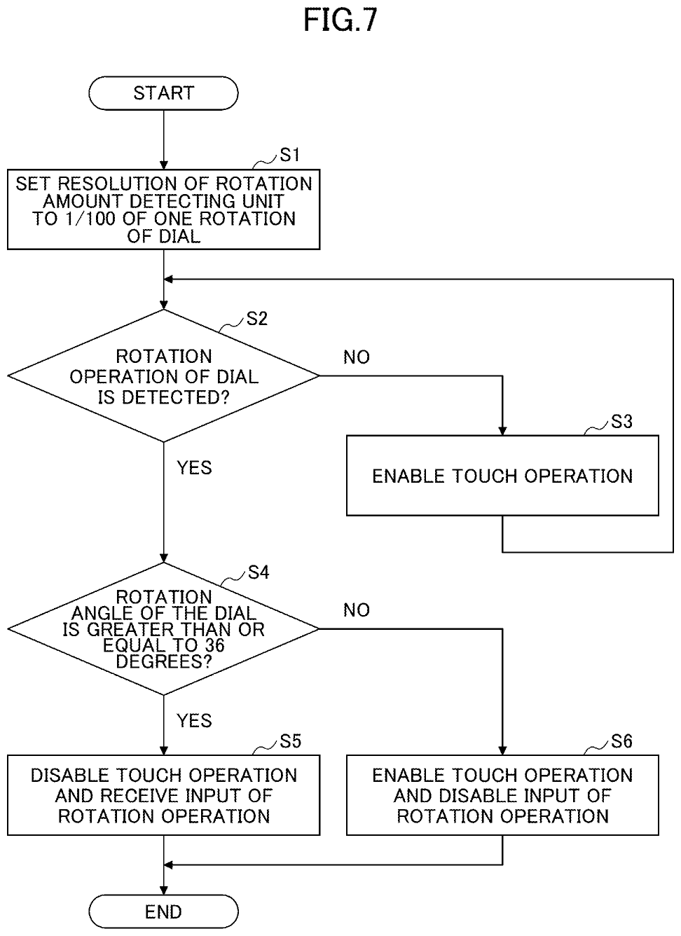

Next, a specific process performed by the main control unit 161 will be described with reference to FIG. 7. In the above description, the sixteen fixed electrode groups 134 are provided, and the sixteen outer edge portions 132B of the movable electrode 132 are also provided. In the following description, it is assumed that 100 fixed electrode groups 134 are provided, and 100 outer edge portions 132B of the movable electrode 132 are provided. Further, in the following description, it is assumed that N=M=10. However, N is an integer greater than or equal to 2, and M is an integer greater than or equal to 1 and less than or equal to N, and thus, N and M may be different.

Therefore, in the following description, the resolution of the rotation amount detecting unit 163 for the rotation angle of the dial 130 is 1/100 of one rotation (360 degrees) of the dial 130, that is, 3.6 degrees when expressed as an angle.

Further, in the following description, it is assumed that when a rotation operation that is 10 times the angle defined by the resolution of the rotation amount detecting unit 163 is input, the rotation amount detecting unit 163 detects the input of the rotation operation of the dial 130. That is, when a rotation operation of the dial 130 that is greater than or equal to 36 degrees is input, the rotation amount detecting unit 163 detects the input of the rotation operation.

Further, in the following, a clicking sensation is provided at every 45 degrees of the rotation of the dial 130. The dial 130 has a click mechanism in the rotation direction, and a click interval at which the click mechanism provides a clicking sensation is L times (L is an integer greater than or equal to N) the angle defined by the resolution.

FIG. 7 is a flowchart illustrating a process performed by the main control unit 161.

When the process is started, the main control unit 161 sets the resolution of the rotation amount detecting unit 163 to 1/100 of one rotation (360 degrees) of the dial 130 (step S1).

The main control unit 161 determines whether a rotation operation of the dial 130 is detected by the rotation amount detecting unit 163 (step S2).

When the main control unit 161 determines that no rotation operation is detected by the rotation amount detecting unit 163 (no in S2), the main control unit 161 enables a touch operation on the touchpad 120 (step S3). Enabling a touch operation means that when a touch operation is detected by the touch detecting unit 162, an operation signal corresponding to the touch operation is output to the ECU or the computer.

After step S3 is completed, the touch operation on the touchpad 120 is in an enabled state. If step S3 is performed for the first time after the power of the input device 100 is turned on, the touch operation on the touchpad 120 is brought into an enabled state. If the process proceeds to step S3 after the touch operation on the touchpad 120 is disabled in step S5, which will be described later, the touch operation in a disabled state is brought back into an enabled state.

When step S3 is completed, the main control unit 161 returns the process to step S2.

When the main control unit 161 determines that a rotation operation is detected by the rotation amount detecting unit 163 (yes in S2), the main control unit 161 determines whether the rotation angle of the dial 130 detected by the rotation amount detecting unit 163 is greater than or equal to 36 degrees (step S4). Note that 36 degrees is 10 times the angle (3.6 degrees) defined by the resolution of the rotation amount detecting unit 163.

When the main control unit 161 determines that the rotation angle is greater than or equal to 36 degrees (yes in S4), the main control unit 161 disables the touch operation even when the touch operation is detected by the touch detecting unit 162, and also the main control unit 161 receives the input of the rotation operation detected by the rotation amount detecting unit 163 (step S5).

When step S5 is completed, the main control unit 161 ends the current cycle of the process. The main control unit 161 repeatedly performs the process from the start to the end illustrated in FIG. 7 while the input device 100 is turned on.

When a user unintentionally touches and rotates the dial 130 while operating the touchpad 120, it is considered that the rotation angle of the dial 130 is small and is less than 10 times the angle (3.6 degrees) defined by the resolution of the rotation amount detecting unit 163. Accordingly, an unintentional input can be avoided.

Further, when the main control unit 161 determines that the rotation angle is not greater than or equal to 36 degrees (no in S4), the main control unit 161 enables the touch operation and disables the input of the rotation operation detected by the rotation amount detecting unit 163 (step S6).

In step S6, if the touch operation is enabled in step S3, the main control unit 161 maintains the enabled state of the touch operation. If the touch operation is disabled in step S5, the touch operation is switched to an enabled state.

When step S6 is completed, the main control unit 161 ends the current cycle of the process. The main control unit 161 repeatedly performs the process from the start to the end illustrated in FIG. 7 while the input device 100 is turned on.

As described above, while a rotation operation of the dial 130 is input, an input of a touch operation on the touchpad 120 is disabled. Accordingly, even if the operator unintentionally touches the touchpad 120 while performing a rotation operation of the dial 130, the input device 100 does not output an operation signal to the ECU or the computer.

Accordingly, the input device 100 having excellent usability can be provided.

Further, when a rotation operation of the dial, which has been input, is stopped, an input of a touch operation on the touchpad 120 is enabled. Therefore, while the user is performing a touch operation on the touchpad 120 without performing a rotation operation of the dial 130, the input device 100 can output an operation signal corresponding to the touch operation. Accordingly, the input device 100 having excellent usability can be provided.

Further, when the amount of rotation detected by the rotation amount detecting unit 163 is less than M times (M is an integer greater than or equal to 1 and less than or equal to N) the angle defined by the resolution, the input of the touch operation on the touchpad 120 is not disabled. Therefore, if the user slightly touches the dial 130 while operating the touchpad 120, the rotation operation is not detected. Accordingly, an unintentional input can be prevented.

In the above description, in step S4, the input of the touch operation on the touchpad 120 is not disabled when the amount of rotation detected by the rotation amount detecting unit 163 is less than M times (M is an integer greater than or equal to 1 and less than or equal to N) the angle defined by the resolution. However, when it is determined that the rotation operation is detected by the rotation amount detecting unit 163 in step S2, the process may proceed to step S5 without performing step S4, and the touch operation may be disabled.

Further, in the above description, the resolution of the rotation amount detecting unit 163 for the rotation angle of the dial 130 is ½ (22.5 degrees) of the click interval (45 degrees) of the dial 130. However, the resolution of the rotation amount detecting unit 163 for the rotation angle of the dial 130 may be 1/N (N is an integer greater than or equal to 2) of the click interval (45 degrees) of the dial 130.

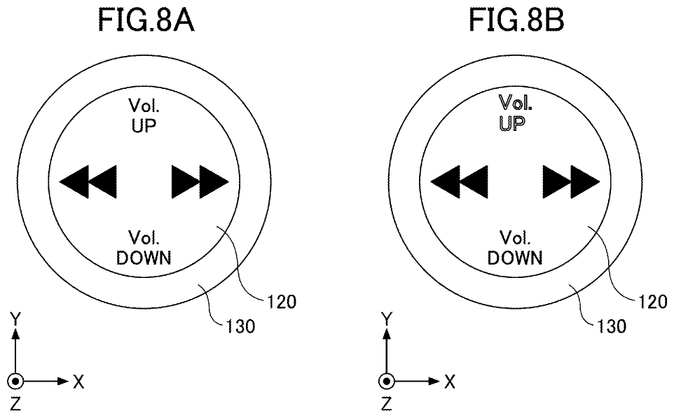

FIG. 8A and FIG. 8A are diagrams illustrating an example of the use of the input device 100. In the example illustrated in FIG. 8A and FIG. 8A, the input device 100 is used as, for example, an input device of a music player.

In FIG. 8A and FIG. 8A, only the touchpad 120 and the dial 130 are depicted for simplicity. FIG. 8A depicts a state in which a touch operation on the touchpad 120 and a rotation operation of the dial 130 are not performed. A rewind arrow and a fast-forward arrow are displayed on the +X side and on the −X side of the touchpad 120, and characters “volume up (vol. up)” and “volume down (vol. down)” are displayed on the +Y side and on the −Y side of the touchpad 120. Further, the dial 130 has a function allowing the user to select music by performing a rotation operation.

The arrows and the characters may be provided on a cover for covering the surface of the touchpad 120, and may be illuminated by turning on/off LEDs provided at the back of the cover. Alternatively, a display such as a liquid crystal display may be provided on the −Z side of the touchpad 120 so as to display the arrows and the characters.

In FIG. 8B, “volume up (vol. up)” is selected on the touchpad 120, and the display color of “volume up (vol. up)” is changed such that it can be visually recognized that “volume up (vol. up)” is selected.

In the input device 100 as described above, even if the user unintentionally touches the touchpad 120 with the finger while performing a rotation operation of the dial 130 to select music, the touch operation on the touchpad 120 is disabled. Accordingly, an unintentional operation can be prevented and usability can be improved.

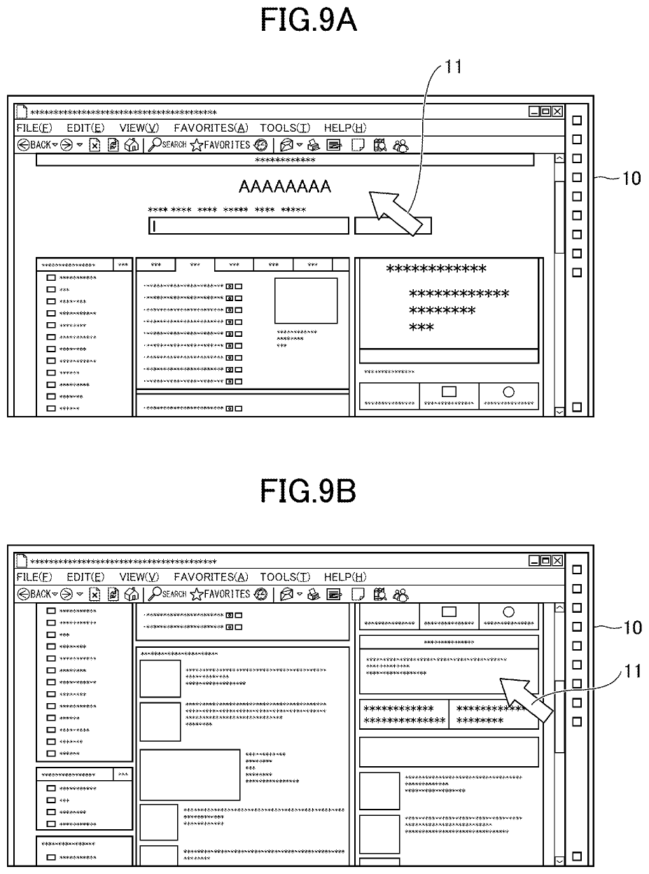

FIG. 9A and FIG. 9B are diagrams illustrating another example of the use of the input device 100. In the example illustrated in FIG. 9A and FIG. 9B, the input device is used as an input device of a personal computer. In FIG. 9AA and FIG. 9B, a display 10 of a personal computer is depicted. As an example, the touchpad 120 has a function for allowing the user to move a cursor 11, and the dial 130 has a function for allowing the user to scroll the display 10.

In FIG. 9A, a touch operation on the touchpad 120 and a rotation operation of the dial 130 are not performed. In FIG. 9B, the display 10 is scrolled and the cursor 11 is moved, as compared to FIG. 9A.

Even if the user unintentionally touches the touchpad 120 with the finger while using the dial 130 to scroll the display 10, the touch operation on the touchpad 120 is disabled. Accordingly, an unintentional operation can be prevented and usability can be improved.

Although the input device according to the embodiments have been described above, the present invention is not limited to the particulars of the above-described embodiments. Variations and modifications may be made without departing from the scope of the subject matter recited in the claims.

What is claimed is

1. An input device comprising:
a touch input part configured to receive an input of a touch operation by an operator;
a rotation input part disposed around the touch input part in plan view and configured to receive an input of a rotation operation by the operator; and
a controller configured to disable the input of the touch operation on the touch input part in response to the input of the rotation operation of the rotation input part being performed.

2. The input device according to claim 1, wherein the controller enables the input of the touch operation on the touch input part in response to the input of the rotation operation of the rotation input part being stopped.

3. The input device according to claim 1, wherein the rotation input part includes a rotation part configured to receive an input of the rotation operation, and a rotation amount detecting unit configured to detect an amount of rotation of the rotation part, and
wherein the rotation amount detecting unit has a detectable amount of rotation corresponding to a resolution, and receives the input of the rotation operation in a case where the input of the rotation operation is greater than or equal to N times the detectable amount of rotation, where N is an integer greater than or equal to 2.

4. The input device according to claim 3, wherein the controller is configured to prevent from disabling the input of the touch operation on the touch input part when the amount of rotation detected by the rotation amount detecting unit is less than M times the detectable amount of rotation, where M is an integer greater than or equal to 1 and less than or equal to N.

5. The input device according to claim 3, wherein the rotation part includes a click mechanism in a rotation direction, and a click interval at which the click mechanism provides a clicking sensation is L times the detectable amount of rotation, where L is an integer greater than or equal to N.
